(19) United States
(12) Patent Application Publication
(10) Pub. No.: US 2013/0039797 A1
(43) Pub. Date: Feb. 14, 2013

(54) MANUFACTURE OF HIGH-PERFORMANCE NEODYMIUM IRON BORON PERMANENT MAGNET MATERIAL

(71) Applicant: Wen Jie Yuan, Tianjin (CN)

(72) Inventor: Wen Jie Yuan, Tianjin (CN)

(21) Appl. No.: 12/995,464

(22) PCT Filed: May 20, 2010
(86) PCT No.: PCT/CN2010/072994

§ 371 Date: Dec. 1, 2010

(30) Foreign Application Priority Data
Apr. 28, 2010 (CN) 201010158035

(51) Int. Cl. H01F 41/02; B22F 9/02; B22F 3/24; B22F 1/00; B22F 3/12

(52) U.S. Cl. 419/29

(57) ABSTRACT

The invention relates to a method of manufacturing high-performance neodymium iron boron permanent magnet material, which improves the coercive force of a magnet by replacing Dy with heavy rare earth element Tb, and simultaneously reduces the production cost by replacing Nd with a small amount of Pr. The neodymium iron boron permanent magnet material containing Pr and Tb comprises (Nd,Pr)ₓ, Fe_{residual}, B_{y}, Dy_{z}, Tbᵤ, Co_{y}, and Al_{w}; the atomic percents of the elements are respectively 7≦x≦15, 5.5≦y≦8, 0.05≦z≦6, 0≦u≦2, 0≦v≦3, 0≦w≦1.5 and Fe and inducted impurity from raw material for the residual. The compounding, smelting, dusting, moulding and sintering processes are performed according to the atomic percents. The added Tb improves the anisotropy field of the molecule of the magnet, therefore, the coercive force of the magnet is obviously improved. Simultaneously, as the anisotropy field of the magnetocrystalline of Pr₂Fe₁₄B is slightly higher than that of Nd₂Fe₁₄B, and the small amount of added Pr also slightly improves the coercive force of the magnet.

### REFERENCE TO PENDING APPLICATIONS

This application is a U.S. National Stage application filed under 35 U.S.C. §371, claiming priority under 35 U.S.C. §365 of International Application No. PCT/CN2010/072994, filed May 20, 2010 in the Chinese Patent Office.

### REFERENCE TO MICROFICHE APPENDIX

This application is not referenced in any microfiche appendix.

### BACKGROUND OF THE INVENTION

The invention relates to a method of manufacturing permanent magnet material, in particular to a method of manufacturing high-performance neodymium iron boron permanent magnet material.

Presently, permanent magnet material is widely applied to various fields of electron, automobile, computer, energy source, mechanism, medical apparatus and the like. Examples include the manufacture of various magnetoelectric machines, vibrating motors, permanent magnet meters, electronic industry (magnet rings and magnet cylinders on cell phone and computers), automobile industry, petrochemical industry, nuclear magnetic resonance devices, audio products (circular magnetic sheets of sound equipment, earphones, loudspeakers and magnetic vibrators), magnetic suspension systems, permanent magnet cranes, magnetic separators, magnetic transmission mechanisms and magnetic therapy equipment. Higher requirements are proposed to the coercive force and the magnetic energy accumulation performance of the neodymium iron boron permanent magnet material in certain areas, and the coercive force and the magnetic energy accumulation performance of the neodymium iron boron permanent magnet material produced by the prior manufacturing method cannot meet the actual demand. Therefore, a manufacturing method which can improve the coercive force and the magnetic energy accumulation performance of the neodymium iron boron permanent magnet material is urgently needed.

### SUMMARY OF THE INVENTION

The invention aims at overcoming the deficiency of the prior art, and providing a method of manufacturing high-performance neodymium iron boron permanent magnet material, which can effectively improve the coercive force and the magnetic energy accumulation performance of the neodymium iron boron permanent magnet material.

The present invention is directed to a method of manufacturing high-performance neodymium iron boron permanent magnet material.

One aspect of the present invention discloses materials with the atomic percents as follows: 7.0 to 15.0 percent of Pr—Nd alloy, 5.5 to 8.0 percent of B, 0.05 to 6.0 percent of Dy, 0 to 2.0 percent of Tb, 0.1 to 0.3 percent of Co, 0.1 to 1.5 percent of Al, and Fe and other inducted impurity from raw material for the residual are mixed for compounding.

The compounded materials are put into a intermediate frequency induction vacuum rapid hardening furnace. The furnace is vacuumized until the pressure is less than 1.0×10⁻¹ Pa. Ar gas is then charged into the furnace for protecting, then heating and melting are performed. After refining operation, molten steel is poured to a rotating cooling copper roller. Alloy cast strips with the thickness being about 0.25-0.35 mm are then prepared. The temperature of the poured molten steel is controlled within 1450 to 1500 DEG C. The alloy cast strips are hydrogenated in a hydrogen decrepitating furnace. The alloy cast strips become very loose particles after low-temperature hydrogen pick-up and high-temperature dehydrogenation. The particles are then prepared into powders with uniform granularity being about 3.0 to 5.0 microns through a jet milling.

After being weighed, the powders are put into a proper press mould and oriented and pressed for molding in a magnetic field with the magnetic strength being larger than 1.8 T;

The molded rough blanks are put into a high vacuum furnace to be sintered. The after vacuum degree is regulated to 2.0×10⁻² Pa. The temperature is increased to 1040 to 1120 DEG C for sintering. The sintering time is 2 to 5 hours, after which time, ageing treatment is performed in the high vacuum furnace. Two stages of ageing treatment is performed in the high vacuum furnace: the temperature for the first stage is 850 to 950 DEG C, the temperature is kept for 1.5 to 3 hours, and then Ar gas is charged for cooling; and the temperature for the second stage is 450 to 550 DEG C, the temperature is kept for 2 to 5 hours, and then Ar gas is charged for cooling.

Compared with the prior art, the invention has the following advantages: the method partially replacing metallic element Dy with metallic element Tb and partially replacing Nd with Pr during the compounding process, effectively improves the anisotropy field of the molecule of the magnet, and effectively improves the coercive force of the neodymium iron boron permanent magnet material, simultaneously as the influence to the magnetic energy accumulation is reduced, the performance of the neodymium iron boron permanent magnet material is greatly improved.

Upon reading the included description, other advantages and various alternative embodiments will become apparent to those skilled in the art. These embodiments are to be considered within the scope and spirit of the subject invention, which is only limited by the claims which follow and their equivalents.

### DETAILED DESCRIPTION OF THE INVENTION

The following detailed description shows the best currently contemplated modes of carrying out the invention. The description is not to be taken in a limiting sense, but is made for the purpose of illustrating the general principles of the invention and the best mode for practicing the invention, since the scope of the invention is best defined by the appended claims. The invention is capable of other embodiments and of being practiced or carried out in a variety of ways. It is to be understood that the phraseology and terminology employed herein are for the purpose of description and not of limitation.

Metallic element Tb is added for partially replacing metallic element Dy during the compounding process, the coercive force of the neodymium iron boron permanent magnet material is effectively improved, and the neodymium iron boron permanent magnet material containing Pr and Tb comprises (Nd,Pr)ₓ, Fe_{residual}, By, Dy_{z}, Tbᵤ, Co_{y}, and Al_{w}; wherein: 7≦x≦15, 5.5≦y≦8, 0.05≦z≦6, 0.05≦u≦2, 0≦v≦3 and 0≦w≦1.5.

### Embodiment 1

The materials with the atomic percents as follows: 12.8 percent of Nd alloy, 0.7 percent of Dy, 1.0 percent of Co, 0.1 percent of Cu, 0.4 percent of Al, 5.95 percent of B, and Fe and other inducted impurity from raw material for the residual are mixed for compounding.

The compounded materials are put into an intermediate frequency induction vacuum rapid hardening furnace. The furnace is vacuumized until the pressure is less than 1.0×10⁻¹ Pa. Ar gas is then charged into the furnace for protecting. Heating and melting are then performed. After refining operation, molten steel is poured to a rotating cooling copper roller. Alloy cast strips with the thickness being about 0.25-0.35 mm are then prepared. The temperature of the poured molten steel is controlled within 1450 to 1500 DEG C. The alloy cast strips are hydrogenated in a hydrogen decrepitating furnace. The alloy cast strips become very loose particles after low-temperature hydrogen pick-up and high-temperature dehydrogenation, and then the particles are prepared into powders with uniform granularity being about 3.0 to 5.0 microns through a jet milling.

After being weighed, the powders are put into a proper press mould and oriented and pressed for molding in a magnetic field with the magnetic strength being larger than 1.8 T.

The molded rough blanks are put into a high vacuum furnace to be sintered. After vacuum degree is regulated to 2.0×10⁻² Pa, the temperature is increased to 1040 to 1120 DEG C for sintering. The sintering time is 2 to 5 hours. Ageing treatment is then performed in the high vacuum furnace. Two stages of ageing treatment is performed in the high vacuum furnace: the temperature for the first stage is 910 DEG C, the temperature is kept for 1.5 to 3 hours, and then Ar gas is charged for cooling; and the temperature for the second stage is 490 DEG C, the temperature is kept for 2 to 5 hours, and then Ar gas is charged for cooling.

Density and magnetic property of the sintered blank are measured.

### Embodiment 2

The materials with the atomic percents as follows: 12.8 percent of Pr—Nd alloy containing 20 percent of Pr, 0.7 percent of Dy, 1.0 percent of Co, 0.1 percent of Cu, 0.5 percent of Al, 5.95 percent of B, and Fe and other inducted impurity from raw material for the residual are mixed for compounding.

The following production steps are the same as that of Embodiment 1 and refer to Embodiment 1.

The contrast of the coercive forces and the magnetic energy accumulation of the neodymium iron boron permanent magnet materials of Embodiment 1 and Embodiment 2 is as on the following table: (test samples adopt φ10×5 cylinders)

| Embodiment | Molecular formula | Br | Hcj | (BM)max |
|---|---|---|---|---|
| Embodiment 1 | Nd_{12.8}Fe_{residual}B_{5.95}Dy_{0.7}Co_{1.0}Al_{0.5} | 13.8KGs | 16.55KOe | 46.56MGOe |
| Embodiment 2 | (Pr—Nd)_{12.8}Fe_{residual}B_{5.95}Dy_{0.7}Co_{1.0}Al_{0.5} | 13.78KGs | 17KOe | 46.58MGOe |

From the above two embodiments, we can see that Pr—Nd alloy which replaces metal Nd slightly improves the coercive force, as the cost of Pr—Nd alloy is lower than that of metal Nd, the cost of the produced magnet is slightly reduced, and the produced magnet has certain market competitiveness.

### Embodiment 3

The materials with the atomic percents as follows: 11.6 percent of Nd alloy containing, 1.9 percent of Dy, 0.5 percent of Tb, 1.2 percent of Co, 0.5 percent of Al, 5.95 percent of B, and Fe and other inducted impurity from raw material for the residual are mixed for compounding.

The following production steps are the same as that of Embodiment 1 and refer to Embodiment 1.

### Embodiment 4

The materials with the atomic percents as follows: 11.6 percent of Pr—Nd alloy containing 20 percent of Pr, 1.9 percent of Dy, 1.2 percent of Co, 0.5 percent of Al, 5.95 percent of B, and Fe and other inducted impurity from raw material for the residual are mixed for compounding.

The following production steps are the same with as of Embodiment 1 and refer to Embodiment 1.

### Embodiment 5

The materials with the atomic percents as follows: 11.6 percent of Pr—Nd alloy containing 20 percent of Pr, 1.4 percent of Dy, 0.5 percent of Tb, 1.2 percent of Co, 0.5 percent of Al, 5.95 percent of B, and Fe and other inducted impurity from raw material for the residual are mixed for compounding.

the following production steps are the same as that of Embodiment 1 and refer to Embodiment 1.

The contrast of the coercive forces and the magnetic energy accumulation of the neodymium iron boron permanent magnet materials of Embodiment 1, Embodiment 2 and Embodiment 3 is as on the following table: (test samples adoptt φ10×5 cylinders).

| Embodiment | Molecular formula | Br | Hcj | (BM)max |
|---|---|---|---|---|
| Embodiment 3 | Nd_{11.6}Fe_{residual}B_{5.95}Dy_{1.9}Co_{1.2}Al_{0.5} | 13.30KGs | 21.68KOe | 43.22MGOe |
| Embodiment 4 | (Pr,Nd)_{11.6} Fe_{residual}B_{5.95}Dy_{1.9}Co_{1.2}Al_{0.5} | 13.28KGs | 22.05KOe | 43.2MGOe |
| Embodiment 5 | (Pr,Nd)_{11.6} | 13.45KGs | 24.80KOe | 44.21MGOe |
| | Fe_{residual}B_{5.95}Dy_{1.4}Tb_{0.5}Co_{1.0}Cu_{0.1}Al_{0.5} | | | |

From the above three embodiments, we can see that the increasing of Tb content, not only greatly improves the coercive force of the magnet, but also improves the magnetic property, and the neodymium iron boron permanent magnet material prepared by adopting the method can be widely applied to various products with higher requirements to temperature resistance.

While embodiments of the present invention have been illustrated and described, such disclosures should not be regarded as any limitation of the scope of our invention. The true scope of our invention is defined in the appended claims. Therefore, it is intended that the appended claims shall be construed to include both the preferred embodiment and all such variations and modifications as fall within the spirit and scope of the invention.

We claim:

1. A method of manufacturing high-performance neodymium iron boron permanent magnet material, the method comprising the steps of:
(a) firstly, the materials with the atomic percents as follows: 7.0 to 15.0 percent of Nd or Pr—Nd alloy, 5.5 to 8.0 percent of B, 0.05 to 6.0 percent of Dy, 0 to 2.0 percent of Tb, 0.1 to 0.3 percent of Co, 0.1 to 1.5 percent of Al, and Fe and other inducted impurity from raw material for the residual are mixed for compounding;
(b) secondly, the compounded materials are put into an intermediate frequency induction vacuum rapid hardening furnace, the furnace is vacuumized until the pressure is less than 1.0×10⁻¹ Pa, then Ar gas is charged into the furnace for protecting, then heating and melting are performed, after refining operation, molten steel is poured to a rotating cooling copper roller, then alloy cast strips with the thickness being about 0.25-0.35 mm are prepared, the temperature of the poured molten steel is controlled within 1450 to 1500 DEG C, the alloy cast strips are hydrogenated in a hydrogen decrepitating furnace, the alloy cast strips become very loose particles after low-temperature hydrogen pick-up and high-temperature dehydrogenation, and then the particles are prepared into powders with uniform granularity being about 3.0 to 5.0 microns through a jet milling;
(c) thirdly, after being weighed, the powders are put into a proper press mould and oriented and pressed for moulding in a magnetic field with the magnetic strength being larger than 1.8 T; and
(d) fourthly, the moulded rough blanks are put into a high vacuum furnace to be sintered, the temperature is increased to 1040 to 1120 DEG C when vacuum degree is regulated to 2.0×10⁻² Pa, the temperature is kept for 2 to 5 hours, then Ar gas is charged to the high vacuum furnace to cool down the high vacuum furnace to lower than 90 DEG C, and then ageing treatment is performed in the high vacuum furnace.

2. A method of manufacturing high-performance neodymium iron boron permanent magnet material according to claim 1, wherein two stages of ageing treatment are performed in the high vacuum furnace: the temperature for the first stage is 850 to 950 DEG C, the temperature is kept for 1.5 to 3 hours, and then Ar gas is charged for cooling; and the temperature for the second stage is 450 to 550 DEG C, the temperature is kept for 2 to 5 hours, and then Ar gas is charged for cooling.

3. A method of manufacturing high-performance neodymium iron boron permanent magnet material according to claim 1, wherein the whole production process is performed under the protection of inert gas, argon gas or nitrogen gas.

4. A method of manufacturing high-performance neodymium iron boron permanent magnet material according to claim 1, wherein the material comprises the components by the atomic content percent of 7.0 to 15.0 percent of metal Nd, 5.5 to 8.0 percent of B, 0.05 to 6.0 percent of Dy, 0.1 to 3.0 percent of Co, 0.1 to 1.5 percent of Al, and Fe and inducted impurity from raw material for the residual.

5. A method of manufacturing high-performance neodymium iron boron permanent magnet material according to claim 1, wherein the Nd element in the components can be replaced with Pr element.
